(19) United States
(12) Patent Application Publication
(10) Pub. No.: US 2006/0152074 A1
(43) Pub. Date: Jul. 13, 2006

(54) Method of managing the parking force generated by a vehicle brake system equipped with electric brakes

(75) Inventors: Philippe Chico, Boulogne Billancourt (FR); Pierre Girod, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 11/115,203

(22) Filed: Apr. 27, 2005

(30) Foreign Application Priority Data
Jan. 11, 2005 (FR) 05 00261

(51) Int. Cl. B60T 17/16

(52) U.S. Cl. 303/89; 303/191; 188/265

(57) ABSTRACT

The invention relates to a method of managing a parking force in a brake system for a vehicle equipped with at least one electric brake having at least one electromechanical actuator which comprises a pusher actuated by an electric motor to apply a force selectively onto friction elements of the brake, the method including the step of causing the pusher to exert a parking force that is initially equal to a nominal parking force on the friction elements so that the parking force is maintained in the absence of drive from the electric motor. According to the invention, the method includes the step of adjusting said parking force at least once.

The invention relates to a method of managing the parking force generated by a vehicle brake system equipped with electric brakes.

### BACKGROUND OF THE INVENTION

Electric brakes for a vehicle, in particular for an aircraft, have at least one electric actuator that comprises a pusher actuated by an electric motor so as to apply a force selectively to the friction elements of the brake.

With a view to preventing the vehicle from moving, e.g. when it is parked, the pusher of the actuator is placed in a position in which it exerts a controlled force on the friction elements, and then the pusher is locked in that position so that it continues to exert a parking force on the friction elements.

The parking force is thus maintained even though the electric motor is not driven, which makes it possible to switch off the power supply to the motor and thus to decrease the electricity consumption of the brake. The parking force can then be maintained while the vehicle is at a standstill and switched off.

However, under certain circumstances, the parking force maintained in this way can decrease to a critical value that no longer makes it possible to hold the vehicle stationary.

That applies, for example, for an aircraft having brakes put in the parking position immediately after severe braking due to an aborted takeoff with a full load on board. After the pusher has been locked, the various component parts of the brake undergo expansion caused by the heat given off by the brake during the severe braking. Such expansion can give rise to the actuator being moved away from the facing friction elements, thereby giving rise to a reduction in the parking force exerted by the actuator, or even to said parking force being reduced to zero, so that the aircraft is no longer held stationary, which can raise serious safety problems.

It should be noted that that problem does not arise for an aircraft equipped with hydraulic brakes, in which the parking force is maintained by connecting the pistons of the brakes to one or more accumulators which continue to apply their pressures on the pistons regardless of the state of expansion of the brakes.

### OBJECT OF THE INVENTION

An object of the invention is to provide a method of managing the parking force exerted by a vehicle brake system equipped with electric brakes that makes it possible to avoid the above-mentioned drawback.

### BRIEF DESCRIPTION OF THE INVENTION

To achieve this object, the invention provides a method of managing a parking force in a vehicle brake system equipped with at least one electric brake having at least one electromechanical actuator which comprises a pusher actuated by an electric motor to apply a force selectively onto friction elements of the brake, the method including the step of causing the pusher to exert a parking force that is initially equal to a nominal parking force on the friction elements so that the parking force is maintained in the absence of drive from the electric motor. According to the invention, the method includes the step of adjusting said parking force at least once.

Thus, adjusting the force makes it possible to prevent the parking force from decreasing, e.g. under the effect of the expansion, to below a minimum force threshold, which might allow the vehicle to move.

In particular, for an actuator having a locking member for locking the pusher, which locking member is activated to maintain the parking force, the method of the invention includes the step of de-activating the locking member prior to adjusting the parking force, and then of re-activating the locking member after adjusting the parking force.

In a first particular implementation of the method of the invention, the step of readjusting the parking force is triggered at instants determined as a function of variation in the parking force.

Preferably, said instants then correspond to the parking force crossing at least one predetermined threshold, e.g. a minimum force threshold in order to prevent the vehicle from being released, or a maximum threshold for preventing the friction elements from being overstressed, or indeed both thresholds.

In a variant, said instants correspond to information representative of expansion of at least one structural part of the brake crossing at least one predetermined threshold.

In a second particular implementation of the method of the invention, the step of re-adjusting the parking force is triggered at instants independent of variation in the parking force.

This type of implementation is particularly well suited for periods during which the vehicle is at a standstill and switched off, and when the only electrical power source is the battery.

In a particular aspect of the invention, prior to the adjustment step, the electric motor of the actuator is servo-controlled so as to prevent the pusher from backing away from the friction elements.

This servo-control prevents a sudden loss of force that might allow the vehicle to move if said loss were to occur on a large number of actuators.

In one implementation of the invention, the adjustment of the parking force comprises the action of controlling the electric motor so as to cause the parking force to coincide with the nominal parking force. The parking force is thus adjusted so that it resumes the initial level to which it was set.

In an implementation adapted to an actuator that is servo-controlled in position, the step of re-adjusting the parking force comprises the following operations, once the pusher is released:

moving the pusher away from the friction elements;

advancing the pusher into a contact position in which it is in contact with the friction elements; and

advancing the pusher over a predetermined distance measured from said contact position.

In one implementation of the method of the invention for a brake system having a plurality of actuators, said method is implemented so that, at any time, the re-adjustment step is performed simultaneously on a fraction only of the actuators of the vehicle.

It is thus possible to keep a sufficient number of actuators engaged to continue holding the vehicle stationary.

Preferably, when the method of the invention is used in a brake system in which at least one of the brakes has a plurality of actuators, said method being implemented so that, at any time, the re-adjustment step is performed simultaneously for a fraction only of the actuators of the brake.

It is thus possible to prevent the brake from being totally released

### BRIEF DESCRIPTION OF THE DRAWINGS

The invention will be better understood on reading the following description given with reference to the accompanying drawings, in which:

FIG. 1 is a diagrammatic view of an aircraft having a plurality of braked wheels;

FIG. 2 is a view in section through a wheel equipped with a brake having electrical actuators;

FIG. 3 is a graph showing how the parking force of an actuator varies over time when a particular implementation of the method of the invention is implemented; and

FIG. 4 is a graph showing how the parking force of an actuator varies over time when another particular implementation of the method of the invention is implemented.

### DETAILED DESCRIPTION OF THE INVENTION

The method of the invention is described in detail below as used in an aircraft A such as the aircraft shown in FIG. 1 which has four braked wheels numbered 1 to 4, carried by undercarriages 15.

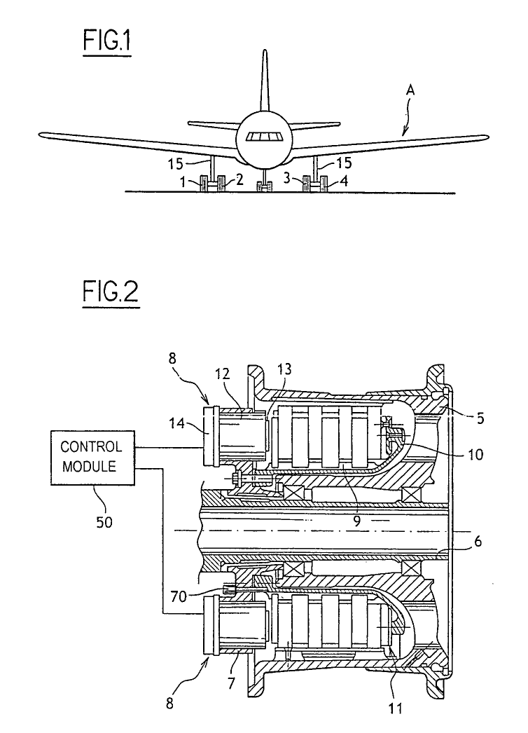

One of the braked wheels is shown in FIG. 2. Each of the wheels comprises a rim 5 adapted to receive a tire (not shown) and mounted to rotate on an axle 6 carried by one of the undercarriages 15 of the aircraft. A ring 7 carrying actuators 8 is mounted on the axle 6. A torsion tube 9 that extends inside the rim 5 and that is terminated by an abutment 10 is fastened to the ring 7. The ring 7, and thus the torsion tube 9, are held in rotation relative to the axle 6 by stop means (not shown).

A stack of disks 11 made up of rotors that are constrained in rotation with the rim 5, and of stators that are constrained in rotation with the torsion tube 9 extends between the abutment 10 and the actuators 8.

Each of the actuators 8 comprises a body 12 in which a pusher 13 is mounted to move linearly facing the stack of disks 11 under drive from an electric motor contained inside the body 12, in order to apply to the stack of disks 11 a controlled pressure force which, by inducing friction forces between the rotors and the stators in the stack of disks, contributes to slowing down rotation of the rim 5, and thus to braking the aircraft A.

Each of the actuators 8 has a locking member 14 adapted to lock the pusher 13 in the position in which it is situated at the time the locking member 14 is activated. The brake system includes a control module 50 adapted to cause the actuators 7 of the brakes to operate either in a controlled mode so that each of the actuators is controlled so as to apply a force selectively on the associated stack of disks 11 in response to a braking instruction, or in a parking mode in which the actuators 8 are locked in one position by means of the locking member 14, in which position the pusher 13 exerts a parking force on the associated stack of disks 11. In the parking mode, the parking force is thus held without using the electric motor, which makes it possible to switch off the electrical power supply thereto.

In order to go over to the parking mode, when the aircraft is parked, the control module 50 firstly causes the pushers 13 of the actuators 8 to apply a controlled force equal to a nominal parking force, and the control module 50 activates the locking members 14 so as to lock the pushers 13. The electrical power supply to the electric motors of the actuators can then be switched off. The pushers 13 as locked in this way continue to exert on the stacks of disks 11 a parking force that holds the aircraft stationary.

However, under certain circumstances, said parking force can decrease dangerously.

Assume, for example, that, before it is held stationary, the aircraft has undergone an aborted takeoff with a full load on board, which often constitutes the circumstances of use that are the most severe for the brakes of a commercial aircraft. The stack of disks 11 has then given off a large quantity of heat in a few seconds.

Then assume that the pushers 13 are locked one or two minutes after the aborted takeoff.

The heat given off by the stack of disks 11 then causes the torsion tube 9 to expand, which tube lengthens progressively to reach its maximum length several minutes after the end of braking.

The expansion of the torsion tube 9 is not compensated by the expansion of the stack of disks 11, and it causes the stack of disks 11 to move away from the actuators 8, which gives rise to a progressive reduction in the parking force.

In order to mitigate that drawback, it is proposed, in the invention, to adjust the parking force of at least one of the actuators 8 by releasing the pusher 13 of said actuator, by correcting the position of the pusher 13, and by locking said pusher 13 again.

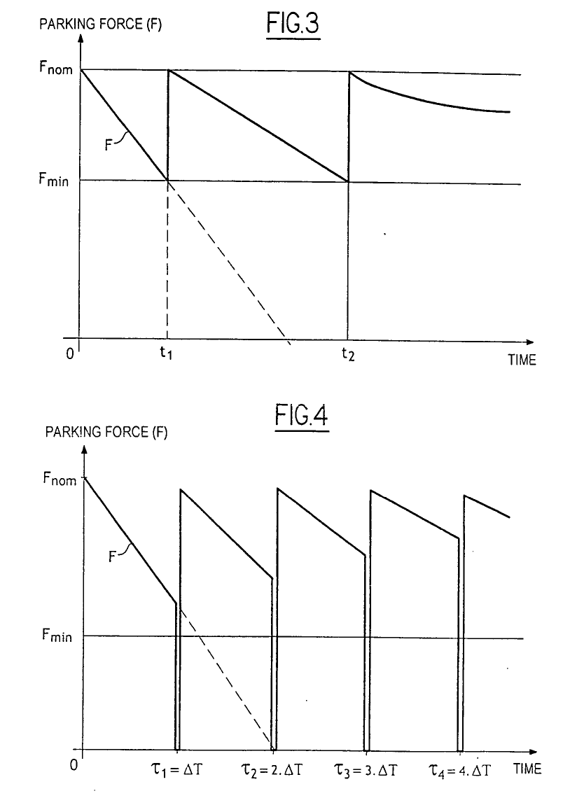

A first implementation of the method of the invention is described in detail below with reference to FIG. 3.

In this example, the method of the invention is used for brakes equipped with actuators 8 that are servo-controlled in force, each actuator having means for measuring the force exerted by the pusher 13 on the associated stack of disks 11.

The graph in FIG. 3 shows how the parking force F exerted by one of the actuators 8 on the associated stack of disks 11 varies over time. Time t=0 corresponds to the time at which the pusher 13 of the actuator is locked by the locking member 14 in a position in which it exerts a force equal to the nominal parking force Fₙₒₘ. As explained above, the parking force F tends to decrease under the effect of the expansion. If the parking force F is allowed to vary with the expansion, the parking force F could even become zero, as shown by the dashed-line curve.

In order to mitigate that drawback, the force exerted by the pusher 13 is measured, and, as soon as it crosses a force threshold Fₘᵢₙ, the parking force is adjusted automatically by triggering automatic adjustment comprising the following steps:

releasing the pusher 13;

correcting the position of the pusher 13 so that the force exerted by the pusher, which force is measured by the force sensor equipping the actuator, is once again equal to the force Fₙₒₘ; and

locking the pusher 13 again.

As can be seen in FIG. 3, at the instants t1 and t2, at which the parking force F reaches the threshold Fₘᵢₙ, the parking force F is then increased again to the level Fₙₒₘ under the effect of the adjustment step of the invention being implemented.

Naturally, at some point in time, the expansion ceases, and the parking force F ceases to decrease, so that it is then unnecessary to increase the force again.

In equivalent manner, rather than measuring the force exerted by the pusher 13 on the stack of disks 11, it is possible to estimate the expansion of the torsion tube 9 by means of a temperature probe 70 (shown in FIG. 2) placed in the torsion tube 9 and delivering a signal that is representative of the expansion of the torsion tube. It then suffices to trigger the parking force adjustment step in response to one or more predetermined expansion thresholds being crossed.

The above-described method can naturally be implemented while the electrical power supply of the aircraft is switched on. The value of the parking force is then monitored continuously.

However, the above-described method can also be implemented while the aircraft is at a standstill and its power supply is switched off. The only electricity source then available is the on-board battery of the aircraft. The brake system is then programmed to check the parking force F of the actuator not continuously as above, but rather at regular intervals (e.g. once every minute), in order to save the battery. If the parking force F is found to be lower than the threshold Fₘᵢₙ, then the parking force F is adjusted in accordance with the invention. Monitoring continues to be implemented at regular intervals for a determined lapse of time (e.g. for 10 minutes) after the aircraft power supply has been switched off.

The above-described method can be implemented on all of the actuators of the aircraft, either one-by-one, or simultaneously. When the method is implemented simultaneously, care is taken to ensure that the total force generated by all of the actuators of the aircraft does not decrease below a minimum which might allow the aircraft to move.

In practice, before releasing the pusher 13 of one of the actuators 8, the associated electric motor is servo-controlled so that it is already holding the pusher in its position. Thus, when the locking member 14 is released, the pusher 12 continues to be held in its position by the electric motor, thereby preventing the force applied by the pusher 13 to the associated stack of disks 11 from falling suddenly and in uncontrolled manner.

In a variant, it is also possible for the motor to be servo-controlled in force so that it exerts on the pusher 13 a force equal to the force measured prior to releasing the pusher 13, thereby unloading the locking member 14 and thus making it easier to release.

In another implementation of the method of the invention, shown in FIG. 4, the method of the invention can also be used for brakes equipped with actuators that are servo-controlled in position. In order to exert a parking force F on this type of actuator, the pusher 13 is caused to come into contact with the stack of disks 11, a contact position in which the pusher 13 is in contact is recorded, and the pusher 13 is moved away from said contact position over a given distance corresponding to the desired controlled force, taking account of brake stiffness; then the pusher 13 is locked so that it exerts a parking force F on the stack of disks. For a brake having stiffness K at ambient temperature, the distance that corresponds to the force Fₙₒₘ is written D.

A particular difficulty arises at this point in that, in order to implement the re-adjustment step, it is important to update the contact position which might have changed due to expansion of the brake.

To this end, implementing the method of the invention comprises the following steps:

releasing the pusher 13;

backing off the pusher 13 until it is no longer in contact with the stack of disks 11;

causing the pusher to advance 13 into a contact position in which it is in contact with the stack of disks 11;

causing the pusher to advance by the distance D measured from said contact position; and

locking the pusher 13.

By updating the contact position each time re-adjustment is made, it is guaranteed that the force applied in this way is substantially equal to the force Fₙₒₘ so that the parking force is increased to a level substantially equal to the initial parking force.

However, it is not possible to guarantee that the parking force re-adjusted in this way is equal to the initial force value Fₙₒₘ, even though the pusher has been displaced over the same distance D, due to the possible modifications in the stiffness K of the brake under the effect of the heat given off. However, such modifications are generally quite small, and the force thus readjusted is, in practice, close to the force Fₙₒₘ.

In the absence of any measurement of the parking force, it is naturally not possible to detect any crossing of a force threshold that is suitable for serving to trigger the re-adjustment of the parking force, unlike what is possible with actuators that are servo-controlled in force.

In this example, it is chosen to trigger re-adjustment of the parking force periodically, each re-adjustment instant τ1 . . . τ4 being spaced apart from the preceding re-adjustment instant by a time interval Δt chosen so that, between two re-adjustments, the parking force F does not have enough time to decrease below a given minimum threshold Fₘᵢₙ, even under the most severe expansion conditions. As shown, the time interval Δt is chosen so that the parking force remains continuously above the force Fₘᵢₙ in in view of foreseeable variation in the parking force F.

Care is taken to ensure that releasing the pusher 13 does not give rise to a sudden loss of force on the actuator in question, by servo-controlling the electric motor in position before the pusher is released.

It should be noted that the step of backing off the pusher 1 requires the force exerted by the actuator on the stack of disks 11 to be released completely, as is clearly visible in FIG. 4, in which, each time a re-adjustment takes place, the parking force F is reduced to zero. It is then not possible to readjust all of the actuators on the aircraft simultaneously without running the risk of releasing the aircraft.

In practice, it is thus necessary to take care that a sufficient number of actuators are maintained locked while the parking forces of the other actuators are being re-adjusted.

Various strategies are thus possible: it can be decided that, on each of the brakes, the method of the invention is implemented on only one actuator at a time, or, at least, on a fraction only of the actuators of the aircraft, the remaining fraction of the actuators being maintained so that none of the brakes is ever released.

It can also be decided to implement the method of the invention simultaneously for all of the actuators of a single brake, which results in momentarily releasing the brake in question. However, the other brakes are maintained under force, so that the aircraft continues to be held stationary. For example, the parking forces of the actuators of brake 1 are re-adjusted, with brakes 2, 3, and 4 remaining in position. Then, the parking forces of the actuators of brake 2 are adjusted, with brakes 1, 3, and 4 remaining in position, and so on until all of the parking forces have been readjusted.

Naturally, it is important to take care to ensure that, at any time, the total braking force exerted by all of the actuators of the aircraft remains sufficient to hold the aircraft stationary, while taking account both of those actuators that are released during the re-adjustment step, and of the diminished parking forces delivered by those actuators that have not yet undergone the re-adjustment step.

The invention is not limited to what is described above, but rather it encompasses any variant lying within the ambit defined by the claims.

In particular, although it is indicated herein that the re-adjustment consists in increasing the parking holding force, the re-adjustment can also consist in decreasing the parking holding force, in the event of said force increasing as a result, for example, of the aircraft cooling considerably at night after being parked and held stationary in desert terrain in the daytime. The parking force can also increase if the actuator was locked at the time when the torsion tube reached its maximum expansion after braking.

Although in this example the actuators act on a stack of disks, the brake can have other types of friction element, such as a disk and brake blocks or a drum and jaws.

Although it is indicated that, during the re-adjustment step, the parking force is increased back up to its nominal level, it is possible to implement other strategies, such as increasing the parking force to a level higher than the nominal force, e.g. if it is observed that the parking force decreases faster than expected, or indeed to a level lower than said nominal force if it is observed that the aircraft is empty and therefore less heavy.

Although in the implementation shown, it is indicated that, in order to adjust the parking force, the pusher is released first, and said pusher is locked again after adjustment, it is not always necessary to release the pusher. Certain actuators have friction locking members that the electric motor can force when the locking member is activated, so that it is possible to adjust the parking force without releasing the pusher first.

Although it is indicated that the parking force is maintained by a locking member, it is also possible to implement the method of the invention on a brake having an irreversible actuator, without a locking member. The parking force is then merely maintained due to the friction in the transmission between the electric motor and the pusher. There is therefore no need to release the pusher before the parking force is adjusted.

What is claimed is:

1. A method of managing a parking force in a vehicle brake system equipped with at least one electric brake having at least one electromechanical actuator which comprises a pusher actuated by an electric motor to apply a force selectively onto friction elements of the brake, the method including the step of causing the pusher to exert a parking force that is initially equal to a nominal parking force on the friction elements so that the parking force is maintained in the absence of drive from the electric motor, said method including the step of adjusting said parking force at least once.

2. A method according to claim 1, adapted to an actuator having a locking member for locking the pusher, which locking member is activated to maintain the parking force, said method including the step of de-activating the locking member prior to adjusting the parking force, and then of re-activating the locking member after adjusting the parking force.

3. A method according to claim 1, wherein the step of readjusting the parking force is triggered at instants determined as a function of variation in the parking force.

4. A method according to claim 3, wherein said instants correspond to the parking force crossing at least one predetermined threshold.

5. A method according to claim 3, wherein said instants correspond to information representative of expansion of at least one structural part of the brake crossing at least one predetermined threshold.

6. A method according to claim 1, wherein the step of re-adjusting the parking force is triggered at instants independent of variation in the parking force.

7. A method according to claim 1, wherein, prior to the adjustment step, the electric motor of the actuator is servo-controlled so as to prevent the pusher from backing away from the friction elements.

8. A method according to claim 1, wherein the adjustment of the parking force comprises the action of controlling the electric motor so as to cause the parking force F to coincide with the nominal parking force.

9. A method according to claim 1, used for an actuator that is servo-controlled in position, wherein the step of re-adjusting the parking force comprises the following operations:
moving the pusher away from the friction elements;
advancing the pusher into a contact position in which it is in contact with the friction elements;
advancing the pusher over a predetermined distance measured from said contact position.

10. A method according to claim 1, used in a brake system having a plurality of actuators, said method being implemented so that, at any time, the re-adjustment step is performed simultaneously only for a fraction only of the actuators of the vehicle.

11. A method according to claim 10, used in a brake system in which at least one of the brakes has a plurality of actuators, the method being implemented so that, at any time, the re-adjustment step is performed simultaneously for a fraction only of the actuators of the brake.
